(19) United States
(12) Patent Application Publication
(10) Pub. No.: US 2025/0266704 A1
(43) Pub. Date: Aug. 21, 2025

(54) METHOD FOR DETERMINING A POWER SETPOINT IN A BATTERY ENERGY STORAGE SYSTEM

(71) Applicant: OCTAVE, Brussel (BM)

(72) Inventors: Jonas ENGELS, Borgerhout (BE); Maxime SNICK, Sint-Niklaas (BE)

(21) Appl. No.: 18/702,435

(22) PCT Filed: Oct. 19, 2022
(86) PCT No.: PCT/EP2022/079148

§ 371 Date: Apr. 18, 2024

(30) Foreign Application Priority Data
Oct. 19, 2021 (BE) BE2021/5820

(51) Int. Cl. H02J 7/00; H02J 3/32

(52) U.S. Cl. CPC H02J 7/007182; H02J 3/32; H02J 7/0048; H02J 7/007192; H02J 2203/20; H02J 2207/20

(57) ABSTRACT

A method to determine the power setpoint of a battery energy storage system (BESS) to store and release electrical energy, using detailed battery cell data and other detailed data from the system and the environment of the system. The battery energy storage system (BESS) comprises a controller configured to apply feature engineering on the obtained detailed measurements and external data to create a state x. Subsequently an optimization function is applied given the state x to create a power setpoint for the battery energy storage system. Besides, he optimization is continuously updated using the detailed historical data of the system itself or from other, similar systems.

### TECHNICAL FIELD

The present invention relates to a battery energy storage system and more particular to a computer-implemented method for determining a power setpoint in a battery energy storage system.

### BACKGROUND ART

Typically, battery packs, and specifically Lithium-ion battery packs are equipped with a battery management system (BMS) which monitors the individual battery cells. The BMS is an embedded system which measures battery cell voltages and temperatures, as well as the current going through the battery pack. Based on these measurements, the BMS estimates the state of charge and sometimes the state of health of the battery pack. The BMS also aims to protect the battery from operating outside of its safe operating area. A BMS communicates with the inverter and the inverter communicates with the energy management system (EMS), which is the system that determines the power setpoint at the connection point of the battery system with a grid. The EMS determines the power setpoint of the battery storage system depending on the application the system is used for.

In known Battery Energy Storage Systems, summarized values of the entire battery pack, such as battery pack state of charge and state of health are communicated from BMS to the EMS. This has the disadvantage that individual battery cell measurements are not available at the EMS. Consequently, the individual battery cell measurements are lost.

A further problem in known systems is that the embedded BMS have limited calculation power and memory and no internet connectivity.

### DISCLOSURE OF THE INVENTION

It is an aim of the present invention to provide an improved battery energy storage system which resolves problems in known systems.

This aim is achieved according to the invention with a computer-implemented method for determining a power setpoint in a battery energy storage system, BESS, used for an application or service, wherein the BESS comprises a battery pack and a power conversion module, wherein the battery pack comprises battery cells and wherein the BESS further comprises means for capturing measurements of the battery cells, the battery pack and the power conversion module, the method comprising:
(a) obtaining raw measurements of the battery cells;
(b) obtaining raw measurements of the battery pack;
(c) obtaining raw measurements of the power conversion module, PCM;
(d) receiving external data relevant for the application or service;
(e) applying feature engineering on the group of the raw measurements of the battery cells combined with the raw measurements of the battery pack combined with the raw measurements of the PCM combined with the external data relevant for the application or service to create a state x;
(f) preparing at least one optimization function configured to use state x to optimize an action u;
(g) optimizing the action u with the at least one optimization function wherein the action u comprises the power setpoint;
(h) sending the power setpoint to the PCM; and
(i) setting the power setpoint at the PCM.

This computer-implemented method has the advantage that different raw measurements are taken into account for creating the state x. The raw measurements of the battery cells contain a lot of valuable data. In particular, they provide information regarding the degradation behaviour and the charging and discharging characteristics of the battery cells. The method makes it possible to precisely determine the impact of charging and discharging cycles on the remaining capacity of the battery cells, determine the internal resistance growth and detect early signs of thermal runaway. The method enables the use of data of the battery cells and the system while in operation, instead of only having to rely on battery cell data from lab tests executed beforehand in artificial conditions. Having a complete view on all available measurements from the individual battery cells enables a more optimal control of the battery pack. The control system is able to take battery cell efficiency losses into account and make a trade-off between delivering a certain utility with the battery and avoiding certain states which induce rapid degradation. As a consequence, it increases the lifetime of the battery pack significantly.

The direct access to all measurements opens a range of opportunities to improve the operation of the battery energy storage system, such as delivering a better service, extending the lifetime, improving monitoring and better predictive maintenance of the system.

Having the data available on another system than a traditional locally embedded system of a BMS provides opportunities for a larger computing and storage capacity. It also allows for the use of more complex algorithms for modelling and power setpoint control optimisation. For instance, it improves safety of the system as it enables early detection of thermal runaway and avoids states which induce rapid degradation or thermal runaway.

Further, by obtaining measurements of the individual battery cells, a model of each battery cell can be developed instead of having a single aggregated model of the entire battery pack. As a result, the setpoint can be determined taking into account much more details resulting from the different measurements. For instance, it is generally known that charging a battery to high cell voltages has a negative impact on the lifetime of the battery cell. However, sometimes this can still be preferred, if the application has at that moment in time a high demand for storage. Having knowledge of the battery cell voltages and the applications request, this computer implemented method can successfully determine the trade-off between charging to a high battery cell voltage or not fulfilling the request of the application. Another example is the amount of power available, which depends on the internal resistance and the voltage of the battery cells. The internal resistance determines the voltage rise measured at the terminal when charging with a certain amount of power. The battery cells can only be charged up to a certain battery cell voltage. If this voltage is reached, the current needs to be decreased in order to prevent damage to the battery cell. This means less charging power is available. The computer-implemented method can use these raw measurements to anticipate the amount of power that will be available at a certain state of charge.

In an embodiment of the invention, the method further comprises storing the raw measurements and data from steps (a) to (d) to create historical measurements and data, and the feature engineering of step (e) of the computer-implemented method is applied on the group of the raw measurements of the battery cells combined with the raw measurements of the battery pack combined with the raw measurements of the PCM combined with the external data relevant for the application or service combined with the historical measurements and data.

This embodiment has the advantage that the method has the ability to store the measurements and data so that historical measurements can be used in state x such that these historical measurements and data are taken into account to determine the optimal setpoint.

In an embodiment of the invention, the raw measurements of the battery cells comprise the voltages of the battery cells and the temperatures of at least a subset of the battery cells.

In an embodiment of the invention, the raw measurements of the battery pack comprise a current going through the battery pack.

In an embodiment of the invention, the raw measurements of the PCM comprise AC and/or DC currents, AC and/or DC voltages, grid frequency or powers.

In an embodiment of the invention, applying feature engineering comprises creating a feature that corresponds to the remaining energy capacity of the battery cells.

In an embodiment of the invention, the at least one optimization function comprises a cost function and a value function, wherein the cost function provides an indication of the current cost and wherein the value function takes into account an estimated future cost and provides an indication of the future cost.

In an embodiment of the invention, the at least one optimization function is

$${min}_{u ∈ U ( x )} E [ g ( x , u , w ) + α J ( f ( x , u , w ) ) ]$$

wherein
g(x, u, w) is a cost function, a function dependent on the state x, the action u and a stochastic variable w,
and J(x′) is the value function of the next state x′, wherein the next state x′ is determined by a state transition function ƒ(x, u, w): x′=ƒ(x, u, w), and
α is a parameter having a value between 0 and 1 (0<α<1), preferably between 0.5 and 1, and more preferably between 0.9 and 0.999.

In an embodiment of the invention, the at least one optimisation function is

$${min}_{\text{?} ( x )} Q ( x , u )$$

$$\text{?} \text{indicates text missing or illegible when filed}$$

wherein
Q(x, u) is a function dependent on the state x and the action u, which is recursively defined as:

$$Q ( x , u ) = E [ g ( x , u , w ) + α {min}_{u ∈ \text{?} ( \text{?} )} Q ( {x}^{′} , u ) ]$$

$$\text{?} \text{indicates text missing or illegible when filed}$$

wherein
g(x, u, w) is a cost function, a function dependent on the state x, the action u and a stochastic variable w,
and the next state x′ is determined by a state transition function ƒ(x, u, w): x′=ƒ(x, u, w), and
α is a parameter having a value between 0.1 and 1, preferably between 0.5 and 1, and more preferably between 0.9 and 0.999.

In an embodiment of the invention, the raw measurements of the battery cells comprise the internal resistance of the battery cells.

In an embodiment of the invention, steps (a) to (e) of the computer-implemented methods are repeated to create new states x′ and the at least one optimisation function is updated over time based on the state x, the new state x′, the action u and the previously used optimisation function at step (g) of the computer-implemented methods.

The advantage of this embodiment is that the optimisation function is improved continuously, online.

In an embodiment of the invention, all information of each step in the computer-implemented methods is stored to create first historical data and the at least one optimisation function is updated over time based on the first historical data.

The advantage of this embodiment is that the features created in the feature engineering step and used in the state x can be reassessed and potentially altered with new features that have become relevant over time. This embodiment also allows a fundamental reassessment of the value functions and the state transition functions, and the way they are modelled, used in the optimisation function.

In an embodiment of the invention, the computer-implemented method further comprises retrieving historical data from other, similar systems to create second historical data and the at least one optimisation function is updated over time based on the second historical data.

The advantage of this embodiment is that also information from other, similar systems is used to improve the value functions and the state transition functions, and the way they are modelled, used in the optimisation function. Also, the features created in the feature engineering step and used in the state x can be reassessed and improved based on data from other, similar systems. Using data from other systems enables a quicker improvement of the model of the optimisation function via a better modelling of the value functions and the state transition functions.

By continuously updating the optimisation functions, the control system operating the computer-implemented method becomes a learning agent, which is able to continuously adapt its control and optimisation algorithms based on new and past information from the cell measurements. Individual battery cell behaviour and degradation can be monitored under real conditions, rather than having to rely solely on predefined models made under artificial operating conditions and to adjust control actions accordingly. Also battery cell degradation models can be improved continuously, making use of new data that becomes available over time. If for instance a battery cell presents a particular degradation pattern under certain conditions, this behaviour (known from the raw measurements) will be taken into account by updating optimisation functions such that the same pattern at other battery cells can be avoided.

The advantage of the embodiment which is able to retrieve historical data from other, similar systems is the ability to share information between control system (BEMS) of different battery systems with the same type of battery cells. This allows the control system (BEMS) operating the computer-implemented method of this embodiment to tap into the information of all battery systems equipped with the control system (BEMS) which drastically increases the available data. By this feature, information of battery cell behaviour and degradation from one system can be used in another system, which improves operation of the other battery system from the start.

In an embodiment of the invention, computer-implemented method steps (a) to (e) are repeated to create new states x′ and to observe a realization of the stochastic variables ŵ and a corresponding observed cost function ĝ from repeated steps (a) to (d), and wherein the at least one optimisation function is updated over time based on the state x, the new state x′, the action u and the observed cost function.

This aim is further achieved according to the invention with a battery energy storage system configured to store and release electrical energy and used for an application or service, the battery energy storage system (BESS) comprising:
a set of rechargeable battery cells electrically connected to form a battery pack;
a power conversion module (PCM) in communication with the battery pack and configured to transfer and modulate electrical energy being transferred between the battery pack and an electrical grid according to a power setpoint;
means for obtaining raw measurements from the set of rechargeable battery cells, the battery pack and the PCM;
means for receiving external data relevant for the application or service; and
a controller in communication with the means for obtaining raw measurements from the set of rechargeable battery cells, the battery pack and the PCM, with the PCM and with the means for receiving external data and configured to (a) obtain raw measurements from the set of rechargeable battery cells, the battery pack and the PCM and to (b) obtain external data; wherein the controller is further configured to (c) apply feature engineering on the obtained raw measurements and external data to create a state x, to (d) prepare at least one optimization function configured to use state x to optimize an action u, to (e) optimize the action u with the at least one optimization function wherein the action u comprises the power setpoint, and to (f) send the power setpoint to the PCM, and wherein the PCM is configured to (g) set the received setpoint.

This battery energy storage system (BESS) has the same advantages and effects as described above for the computer-implemented method. This BESS has the advantage that different raw measurements are taken into account for creating the state x. The raw measurements of the battery cells contain a lot of valuable data. In particular, they provide information regarding the degradation behaviour of the battery cells and regarding the impact of specific charging and discharging cycles. Having a complete view on all available measurements from the individual battery cells allows to control the battery pack more optimal and as a consequence to increase the lifetime of the battery pack significantly. The direct access to all measurements opens a range of opportunities to improve the operating of the battery energy storage system, such as delivering a better service, extending the lifetime, improving monitoring and better predicting maintenance of the system.

Further, by obtaining measurements of the individual battery cells, a model can be developed of each battery cell instead of having one aggregated model of the battery pack. As a result, the setpoint can be determined taking into account much more details resulting from the different measurements.

In an embodiment of the invention, the raw measurements of the battery cells comprise the voltages of the battery cells and the temperatures of the battery cells.

In an embodiment of the invention, the raw measurements of the battery pack comprise a current going through the battery pack.

In an embodiment of the invention, the raw measurements of the PCM comprise AC and/or DC currents, AC and/or DC voltages, grid frequency or powers.

In an embodiment of the invention, applying feature engineering comprises creating a feature that corresponds to the remaining energy capacity of the battery cells.

In an embodiment of the invention, the at least one optimization function comprises a cost function and a value function, wherein the cost function provides an indication of the current cost and wherein the value function takes into account an estimated future cost and provides an indication of the future cost.

In an embodiment of the invention, the at least one optimisation function is

$${min}_{u ∈ U ( x )} E [ q ( x , u , w ) + α J ( f ( x , u , w ) ) ]$$

wherein
g(x, u, w) is a cost function, a function dependent on the state x, the action u and a stochastic variable w,
and J(x′) is the value function of the next state x′, wherein the next state x′ is determined by a state transition function ƒ(x, u, w): x′=ƒ(x, u, w), and
α is a parameter having a value between 0.1 and 1, preferably between 0.5 and 1, and more preferably between 0.9 and 0.999.

In an embodiment of the invention, the at least one optimisation function is

$${min}_{u ∈ \text{?} ( x )} Q ( x , u )$$

$$\text{?} \text{indicates text missing or illegible when filed}$$

wherein
Q(x, u) is a function dependent on the state x and the action u, which is recursively defined as:

$$Q ( x , u ) - E [ g ( x , u , w ) + α {min}_{u ∈ \text{?} ( \text{?} )} Q ( {x}^{′} , u ) ]$$

$$\text{?} \text{indicates text missing or illegible when filed}$$

wherein
g(x, u, w) is a cost function, a function dependent on the state x, the action u and a stochastic variable w,
and the next state x′ is determined by a state transition function ƒ(x, u, w): x′=ƒ(x, u, w), and
α is a parameter having a value between 0.1 and 1, preferably between 0.5 and 1, and more preferably between 0.9 and 0.999.

In an embodiment of the invention, the raw measurements of the battery cells comprise the internal resistance of the battery cells.

In an embodiment of the invention, the controller is configured to repeat (a) to (c) to create new states x′ and the controller is further configured to update the at least one optimisation function over time based on the state x, the new state x′, the action u and the observed cost g, part of the previously used optimisation function in step (g).

In an embodiment of the invention, the controller is configured to store all information of each controlling step (a) to (f) to create first historical data and the controller is further configured to update the at least one optimisation function over time based on the first historical data.

In an embodiment of the invention, the controller is configured to retrieve historical data from other, similar systems to create second historical data and the controller is further configured to update the at least one optimisation function over time based on the second historical data.

In an embodiment of the invention, the controller is configured to repeat controlling steps (a) to (c) to create new states x′ and to observe a realization of the stochastic variables ŵ and corresponding cost function ĝ from the repeated controlling steps (a) to (b), and wherein the at least one optimisation function is updated over time based on the state x, the new state x′, the action u and the observed cost function ĝ.

All advantages and effects described in the context of embodiments of the computer-implemented methods are applicable on the corresponding embodiments of the battery energy storage systems. They are therefore not repeated but included by referring to these.

### BRIEF DESCRIPTION OF THE DRAWINGS

The invention will be further elucidated by means of the following description and the appended figures.

FIG. 1 shows a battery energy storage system according to an embodiment of the invention.

FIG. 2 shows an alternative battery energy storage system according to an embodiment of the invention.

FIG. 3 illustrates a method for determining a power setpoint in a battery energy storage system (BESS) using raw battery cell measurements according to an embodiment of the invention.

FIG. 4 illustrates an alternative method for determining a power setpoint in a battery energy storage system (BESS) using raw battery cell measurements according to an embodiment of the invention.

FIG. 5 is a diagram of an iteration loop according to an embodiment of the invention.

### MODES FOR CARRYING OUT THE INVENTION

The present invention will be described with respect to particular embodiments and with reference to certain drawings but the invention is not limited thereto but only by the claims. The drawings described are only schematic and are non-limiting.

Further, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Furthermore, the various embodiments, although some may be referred to as “preferred” are to be construed as exemplary manners in which the invention may be implemented rather than as limiting the scope of the invention.

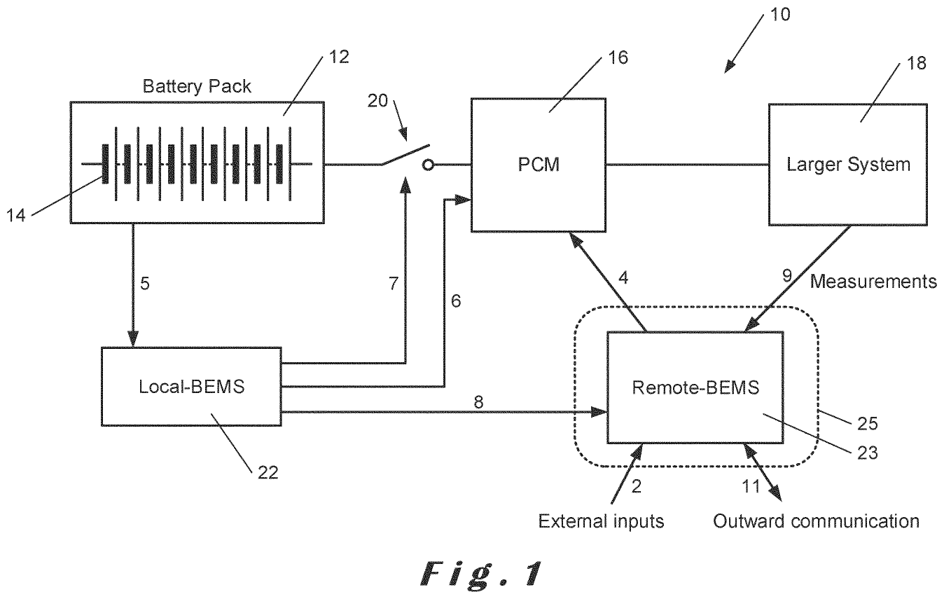

FIG. 1 illustrates a battery energy storage system (BESS) 10 with an integrated battery and energy management system (BEMS) according to an embodiment of the invention.

The BESS 10 has a battery pack 12. The battery pack 12 has a number of battery cells 14, which are connected in a certain electrical configuration to each other. The electrical configuration may be in-series, in-parallel or a combination of in-series and in-parallel. The battery pack 12 has a certain DC voltage. The DC voltage varies between limits depending mainly on the state of charge of the battery cells 14.

The battery pack 12 is electrically connected to a power conversion module (PCM) 16 which can be an AC/DC inverter or a DC/DC converter. The PCM 16 converts the DC battery voltage to the desired AC voltage when it is an AC/DC inverter. When the PCM 16 is a DC/DC converter, the PCM 16 converts the DC voltage of the battery pack 12 to a desired DC voltage at a connection point with the rest of the system 18. The PCM 16 is able to manage currents and power flows in and out of the battery pack 12. And the PCM 16 is able to manage currents in and out with the system 18 at the connection point of the PCM 16 with the system 18. Which PCM 16 is used depends on the application for which the BESS 10 is used and on the system 18.

A switch 20 may be provided between the battery pack 12 and the PCM 16 allowing to switch off the battery pack 12 for maintenance or to prevent a potential safety hazard. In an alternative embodiment, the switch may be a relay. A first local battery and energy management system (local-BEMS) 22 is embedded on the battery pack 12. The local-BEMS 22 executes many of the functions executed by a traditional embedded BMS, except for the state estimation functions. The local-BEMS 22 measures certain values of the battery cells 14, such as voltage, temperature and current, performs cell balancing and takes the necessary security actions by guarding the safe operating conditions of the battery pack 12. The cell measurements such as voltage, temperature and the pack measurements such as current and total voltage are illustrated on FIG. 1 by the arrow with reference number 5. The local-BEMS 22 may determine for example if the maximum or minimum cell voltages are reached and prevent charging the battery pack 12 beyond these voltages. The local-BEMS 22 may communicate these safe operating conditions to the PCM 16. The communication from the local-BEMS 22 to the PCM 16 is illustrated on FIG. 1 by the arrow with reference number 6. The PCM 16 can then ensure that current into and out of the battery pack 12 remains within these safe operating conditions. If a switch 20 is provided between the battery pack 12 and the PCM 16, the local-BEMS 22 may also control this switch 20 when cell voltages or temperatures are getting too high or too low to ensure safe operating conditions. This control of the local-BEMS 22 to the switch 20 is illustrated on FIG. 1 by the arrow with reference 7.

Next to the local-BEMS 22, the BESS 10 has a remote battery and energy management system (remote-BEMS) 23 located on a remote infrastructure 25 which may be a remote server or any other type of cloud infrastructure. The local-BEMS 22 is able to communicate with the remote-BEMS 23. This is illustrated on FIG. 1 by the arrow with reference 8. All or a selection of the measurements done by the local-BEMS 22, such as voltages, temperatures and currents of the battery cells 14 and/or the battery pack 12, are sent to the remote infrastructure 25. The remote-BEMS 23 uses the values sent by the local-BEMS 22 to determine a power or current setpoint of the PCM 16 based on a pre-defined objective which depends on the specific application for which the BESS 10 is used. Examples of pre-defined objectives are maximize self-consumption, capture arbitrage opportunities on electricity markets or perform peak shaving. In this calculation, the remote-BEMS may perform battery cell state estimations and parameter calculations, like state of charge (SoC), remaining capacity, internal resistance or impedance. The remote-BEMS 23 manages the energy and power that goes into or comes out from the battery pack 12.

The remote-BEMS 23 may have the ability to communicate with the outside world over the internet. The remote-BEMS 23 may also have an outward communication to a database or a monitoring system. The outward communication is illustrated in FIG. 1 by the arrow with reference 11.

The remote-BEMS 23 receives also measurements from the larger system 18. This is illustrated in FIG. 1 by the arrow with reference 9.

The remote-BEMS 23 has access to all measurements sent by the local-BMS 22. The remote-BEMS 23 has also access to historic measurements sent, and previously estimated states or parameters. In some embodiments, the remote-BEMS 23 may have access to data from external sources, such as current weather, weather forecasts, grid imbalances or flexibility requests from grid operators. The input of external data to the remote-BEMS 23 is illustrated in FIG. 1 by the arrow 2. The remote-BEMS 23 uses all this available data to run a model which predicts the future needs of the application for which the BESS 10 is used, for example for grid balancing. The remote-BEMS 23 computes a control signal, a required power setpoint at the output of the PCM, which is sent to the PCM 16. The communication of the remote-BEMS 23 to the PCM 16 of the required power setpoint is illustrated in FIG. 1 by the arrow with reference 4.

The PCM 16 executes the power setpoint taking into account safety boundaries calculated by the local-BEMS 22. New measurements are then made by the local-BEMS 22 and the entire cycle starts over.

In an embodiment of the invention parts of the remote-BEMS 23 may be implemented locally, for example the direct communication with the inverter, and other parts may be implemented in the cloud, for example running an algorithm to determine the setpoints.

The remote-BEMS 23 may have via internet communication access to inputs and external data. The desired data is dependent on the specific application for which the battery energy system is used. Typical inputs are measurements of power and/or current of the connection point of the inverter with the larger system (for instance the electrical grid), and other measurements from the site where the battery system is located or the larger system, such as local photovoltaic (PV) generation power or the power at the connection point of the local site with the entire electrical grid. Other external inputs such as weather forecasts, wholesale electricity market prices or measures indicating the general imbalance of the electrical grid may be used in the remote-BEMS 23 as well.

The remote-BEMS 23 operates the battery energy storage system, (BESS), in such a way that a cost function, corresponding to the application for which the BESS is used, is satisfied over the lifetime of the BESS.

This means the remote-BEMS does not only take the cost function of the application into account, but also for instance effects of the charging and discharging actions on the degradation of the battery cells 14, and the efficiency of the charging and discharging. For example, charging at very low temperatures or charging at high power or high cell voltages can result in rapid degradation of the battery cells. Therefore, the remote-BEMS 23 may decide to enter these operating conditions only when the reduction in cost function is high enough to compensate for the increased degradation. Charging at high power might also result in high efficiency losses if the cells have high internal resistance. The remote-BEMS can therefore choose to avoid these conditions, or only enter them when the reduction in cost function compensates for the efficiency losses.

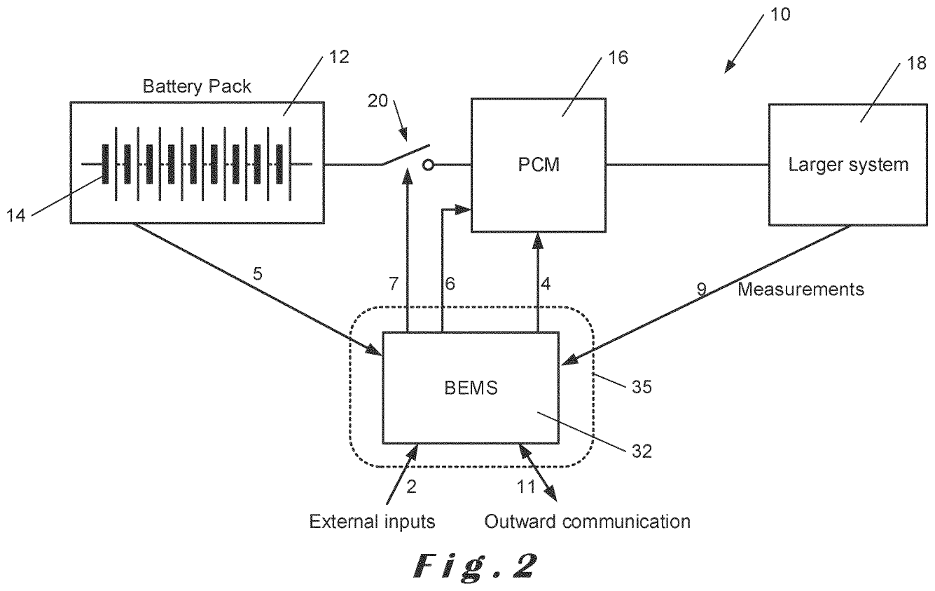

FIG. 2 illustrates an alternative embodiment of the invention wherein the local-BEMS 22 and the remote-BEMS 23 from the embodiment of FIG. 1 are brought together in a single battery and energy management system 32 which is part of a controller 35 of the battery energy storage system.

In an example of the current invention, the entire optimal control problem can be illustrated by a discrete time infinite horizon optimal control problem.

$${min}_{\text{?}} {lim}_{N \to ∞} [ {\sum }_{k = 0}^{N - 1} {a}^{k} {g}_{k} ( {x}_{k} , {u}_{k} , {w}_{k} ) ] \qquad ( 1 )$$

$$subject to {u}_{k} ∈ {U}_{k} ( {x}_{k} ) \qquad ( 2 )$$

$${x}_{k + 1} = {f}_{k} ( {x}_{k} , {u}_{k} , {w}_{k} ) \qquad ( 3 )$$

$$\text{?} \text{indicates text missing or illegible when filed}$$

Herein is k an indicator of the discrete time step and xx is a vector containing the state of the entire system at timestep k. The state includes the current and historic raw battery cell measurements of the system. Optionally, the state may also contain other relevant information, such as historical market prices or local solar generation power. Optionally, the state x can also include combinations of measurements, calculations on the measurements or a selection of any of the previous. uₖ is a vector representing the various options for control, for example the AC power setpoint of the power conversion module (PCM), which is limited to a feasible set Uₖ(xₖ) which depends on the state of the system. wₖ is a vector containing all external stochastic parameters. E[.] represents the expected value calculated over the stochastic parameters. The expected value can also be replaced by any other measure over the stochastic parameters, for instance to include a notion of risk one may choose to include the variance as well. α^{k} is a discounting parameter and gₖ(xₖ, uₖ, wₖ) is the cost function at time step k. The cost function may be the negative of a utility function. Finally, ƒₖ(xₖ, uₖ, wₖ) denotes the state transition function.

In this equation, alpha α is a number between zero and one, not including 1 (0<α<1), which determines the trade-off between minimizing the immediate cost function g(x, u, w) and minimizing the value of the next state x′=ƒ(x, u, w), represented by the value function ƒ(x′).

A larger α puts more weight on the future value in the optimization, while a smaller α gives more weight to satisfying the immediate cost function.

The value of α is set depending on the preferences of the operator. It can be determined by running an iterative process, where for various values of α, a value function is determined using value iteration or any other approach. The resulting value function can then be simulated on a model, the results of the optimization can be compared for various values of α, and the best value can be selected. Typically, α is a value between 0.9 & 0.999.

This control problem can be reformulated into the following Bellman equation:

$$J ( x ) = {min}_{u ∈ U ( \text{?} )} E [ q ( x , u , w ) + α J ( f ( x , u , w ) ) ]$$

$$\text{?} \text{indicates text missing or illegible when filed}$$

These equations define a value function J(x) which depends on the state x wherein the state x includes raw battery measurements and other external information. The value function J(x) can be interpreted as the cost-to-go of the system at state x. It is not possible to determine the exact value of the value function. Therefore, an approximation or a heuristic is used. The approximation or modeling of the value function will be improved when more data becomes available. The same effect is reached with the transfer function ƒ(x, u, w), also the transfer function can be modelled better and better when more data becomes available.

Alternatively, the value function can also be written as a Q-function Q(x, u):

$$Q ( x , u ) - E [ g ( x , u , w ) + α {min}_{u ∈ \text{?} ( \text{?} )} Q ( {x}^{′} , u ) ]$$

$$where {x}^{′} = f ( x , u , w ) .$$

$$\text{?} \text{indicates text missing or illegible when filed}$$

In this alternative, the Q-function Q(x, u) needs to be learned instead of the value function ƒ(x). An advantage of a Q-function is that it allows a model-free operation: there is no need to model the cost function g(x, u, w) or the expected value E[.] to calculate the optimal action uₖ. With the Q-function, the optimal control can be found by calculating

$${min}_{u ∈ U ( x )} Q ( x , u ) ,$$

given the current state x. In case the action space is one-dimensional, e.g. in case it concerns just the AC power setpoint of the PCM, this minimization can be easily calculated using e.g. a line search algorithm, varying the action u in the Q-function while keeping the state x constant to the current state.

For the learning of the value function or the Q-function, approximate dynamic programming or reinforcement learning can be used.

Applying this optimal control problem to the stationary battery energy storage systems, including using the historic and current raw battery cell measurements as part of the state of the system x, provides the ability to build detailed models used to solve this optimal control problem and to improve these models continuously.

In an alternative, a finite horizon version of the problem may be used.

For the finite horizon, the Bellman equation results in

$${J}_{k} ( {x}_{k} ) = {min}_{{u}_{k} ∈ {U}_{k} ( {x}_{k} )} E [ {g}_{k} ( {x}_{k} , {u}_{k} , {w}_{k} ) + {J}_{k + 1} ( {f}_{k} ( {x}_{k} , {u}_{k} , {w}_{k} ) ) ] , ∀ k = 0 , … , N - 1$$

$${J}_{N} = {g}_{N} ( {x}_{N} )$$

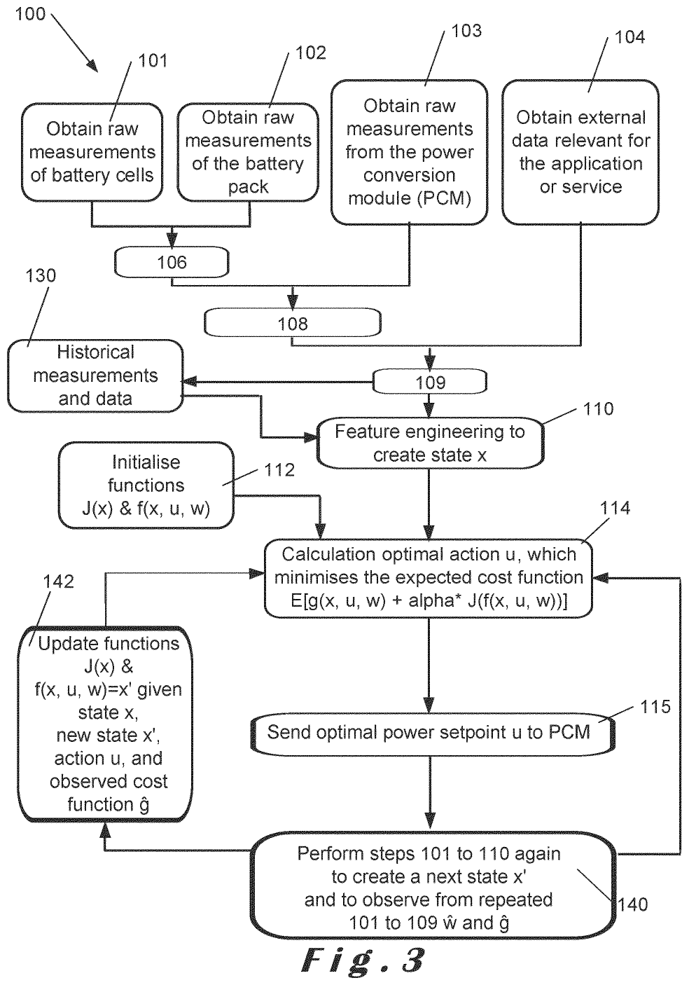

FIG. 3 illustrates a method 100 for determining a power setpoint in a battery energy storage system (BESS) using raw battery cell measurements. The method allows for online learning and improvement of the models and/or functions used.

In a first step, data is gathered to create a first state of the BESS. In 101, raw measurements of the battery cells 14 are captured such as battery cell voltages and battery cell temperatures. Other parameters of the battery cells may be measured and gathered too. In 102, raw measurements of the battery pack are captured such as battery pack voltage and battery pack current, i.e. the current going through the pack. Other parameters of the battery pack may be measured and gathered too.

The raw measurements of the battery cells captured at 101 together with the raw measurements of the battery pack captured at 102 define together at 106 a state of the battery pack 12. In other words, at step 106, the raw measurements of the battery cells and the raw measurements of the battery pack are combined or concatenated.

At 103, measurements from the power conversion module (PCM) are captured such as AC and/or DC currents, AC and/or DC voltages, grid frequency, or powers. Other parameters of the PCM may be measured and gathered too.

The state of the battery pack 106 together with the measurements from the PCM captured at 103 result together at 108 in a state of the battery energy storage system.

At 104, external data relevant for the application or service is captured such as solar forecasts in case the battery energy storage system is used to store solar energy, other weather data and power market data in case the battery is used to perform arbitraging on the power markets or grid imbalance data in case the battery is used to alleviate grid imbalances. Other external data relevant for the application or service may be captured too.

The state of the battery energy storage system 108 together with the external data captured at 104 define together at 109 a state of the entire system wherein the entire system can be described as the full state of the battery storage system and its environment. The full state is added to a historical measurements and data database 130 for use in future iterations.

The full state of the entire system 109 can be very large and at step 110 the method is using feature engineering to create a state x from the state of the entire system 109 optionally combined with historical measurement and data retrieved from the historical measurement and data database 130. Feature engineering as such is known and can for example comprise of:
selecting in the group of measurements from 101, 102, 103 and 104 the most useful measurements (data points) to be represented in the state x,
combining measurements (data points) in the group of measurements from 101, 102, 103 and 104 to create one single entry in the state x,
integrating measurements (data points) in the group of measurements from 101, 102, 103 and 104 to be included in the state x, or
using historical measurements (data points) from measurements at 101, 102, 103 and 104 captured in the past and stored in the historical measurement and data database 130 when performing previous executions of the method in the state x, or
selecting minimum, maximum and average voltages of the battery cells, and selecting the minimum, maximum and average temperatures of the battery cells, or
selecting the minimum, maximum and average voltages of the battery cells, and selecting the minimum, maximum and average temperatures and selecting the minimum and maximum currents going through the battery cells or through the battery pack
selecting the aggregated AC or DC power of the PCM over time.

In this feature engineering step 110, one or more of the above examples of feature engineering may be used. Other feature engineering known in the art may be applied too. The result of the feature engineering step 110 is the state x. To be able to further process the state x at least one function must be initialised.

This is illustrated at step 112 in FIG. 3. The at least one function may be the value function J(x) described earlier in the description together with the state transition function ƒ(x, u, w) also described earlier in the description and going together with the value function.

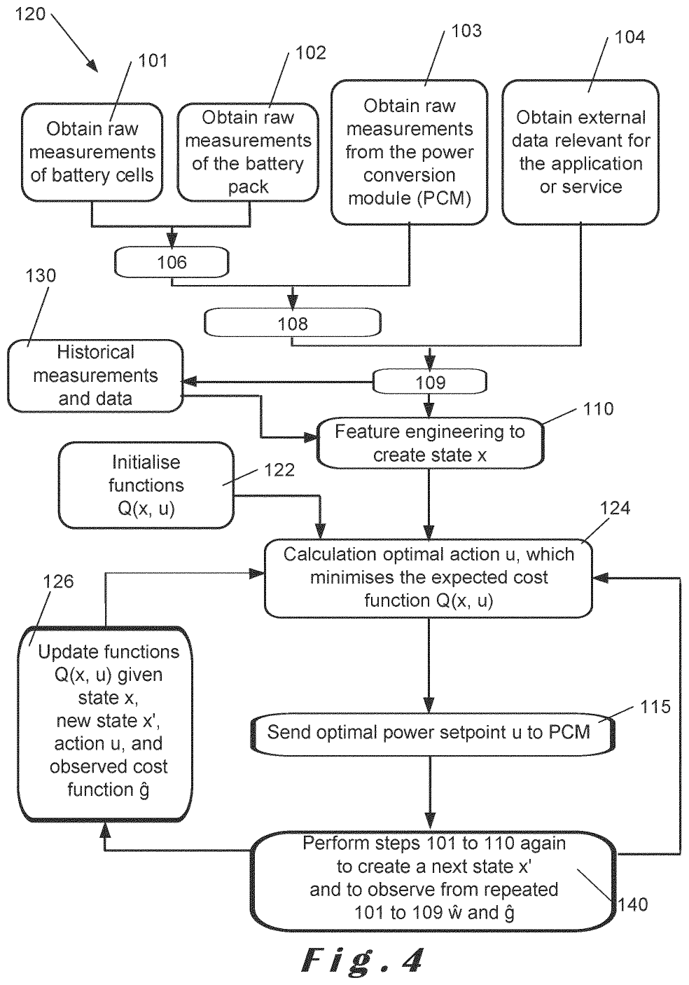

In an alternative method 120 for determining a power setpoint in a battery energy storage system (BESS), the at least one function may be the Q-function Q(x, u) described earlier in the description. This alternative method is illustrated in FIG. 4.

To initialise the at least one function at step 112 or 122 in the embodiments of FIG. 3 and FIG. 4 respectively, data is used from other systems with similar configuration (similar battery cells, inverter, function), which are already in operation and hence have historical data available. This historical data is used to create a first approximation of the functions to be initialized.

Alternatively, if a system with similar configuration is not available, the at least one function can be initialized using a theoretical model used to create a simulator of the system. The simulator is used to simulate the system when a certain action is performed on it. Using known value iteration or Q-iteration methods, the value function or Q-functions respectively are subsequently constructed using the data from the simulator. As a result, the at least one function is initialized.

As a further alternative, other approximation methods for the value function or the Q-function can also be used to initialize the at least one function, such as a heuristic created by an expert in the field.

Initialization can also be done by combining above alternatives. In an embodiment, a combination of historical data from a similar system with theoretical models and heuristics is used to initialize the at least one function. For example, if historical data from a system with the same type of battery cells but in another configuration is available, this historical data is used to create a model of the system. And, subsequently, this model is used to perform the known value iteration or Q-iteration to construct the value function or the Q-function respectively.

In embodiments corresponding to FIG. 3 using the value iteration to construct the value function, the state transition function ƒ(x, u, w) is also initialized by fitting it to historical data, a theoretical model, or a combination of the two.

With state x available from step 110 and the at least one function initialized at step 112 or 122, both can be brought together at step 114 or 124 in the embodiments of FIG. 3 and FIG. 4 respectively. At step 114 or 124 in the embodiments of FIG. 3 and FIG. 4 respectively, the optimal action u is calculated.

In an embodiment using the value function and the state transition function as illustrated in FIG. 3, the optimal action u is calculated by solving (approximately) following optimization problem:

$${min}_{u ∈ U ( x )} E [ g ( x , {u}_{} , w ) + α J ( f ( x , u , w ) ) ]$$

The optimization minimizes the expected cost function E[g(x, u,w)+alpha*J(ƒ(x, u,w)]. To do this, a model of the cost function g(x, u,w), the state transition function ƒ(x, u, w) and the stochastic variables w is created.

In an alternative embodiment using Q-function as illustrated in FIG. 4, the optimal action u is calculated by the optimization problem:

$${min}_{u ∈ U ( x )} Q ( x , u )$$

The action u is the power setpoint of the PCM at the connection of the battery energy storage system (BESS) with the electrical grid.

In an embodiment where the action u is one-dimensional, like in the case of determining a single power setpoint of the PCM, the optimization can be performed by a line-search algorithm.

The result of step 114 or 124 in the embodiments of FIG. 3 and FIG. 4 respectively is that the action u is determined, which is the optimal power setpoint of the PCM. At step 115, the optimal power setpoint (action u) is sent to the PCM to be executed by the PCM.

The PCM subsequently executes the optimal power setpoint (action u). Now the optimal power setpoint is set, the whole process restarts. At step 140, steps 101 to 110 are performed again to create now a new state x′. New measurements are captured at steps 101, 102, 103 and 104. These new measurements are combined again in steps 106, 108 and 109.

Feature engineering is again applied to create a new state x′ at step 110.

The actual realization ŵ of the stochastic variables w can be observed from the combined measurements in step 109. The observed cost function (the actually realized cost function) ĝ is then calculated as follows:

ĝ=g(x,u,ŵ).

At step 142 or 126 in the embodiments of FIG. 3 and FIG. 4 respectively, the value and state transition functions of step 112 or the Q-function of step 122 in FIG. 3 and FIG. 4 respectively are updated with data from the previous process or processes including given previous state x, new state x′, action u and the observed cost function.

In an embodiment, the value function is updated using the observed cost function ĝ, the previous state x and the new state x′ according to the following equation:

$$J ( x ) = γ J ( x ) + ( 1 - γ ) ( \hat{g} + α J ( {x}^{′} ) )$$

wherein γ is a factor which determines the rate to which the value function is updated or learned.

In an embodiment using the Q-function, the Q-function is updated in a similar way:

$$Q ( x , u ) = γ Q ( x , u ) + ( 1 - γ ) ( \hat{g} + α {max}_{u} Q ( {x}^{′} , u ) )$$

Using the updated value functions and state transition functions in the embodiment of FIG. 3 and the updated Q-functions in the embodiment of FIG. 4, optimization is again done at step 114 or 124 in the embodiments of FIG. 3 and FIG. 4 respectively to arrive at a new action u and thus a new optimal power setpoint. At step 115, the new optimal power setpoint u′ is again sent to the PCM and the PCM executes subsequently the new optimal power setpoint. The method is now ready with the second flow or process (first iteration) and is ready to start again with capturing new measurements to create a state x″ (second iteration). By continuously running the method, the power setpoint is continuously optimized and the power strategy applied. After running iterations of the method for some time, e.g. every couple of days, every month, or any other timeframe, the historical data of the system can be analysed and used to improve the steps in the method. For example the value function J(x) or the Q-function Q(x) can be re-assessed, the features used to create state x can be re-assessed, or the state transition function ƒ(x, u,w) can be re-created. In this improvement process, data from one battery cell can be used to model the other cells. In some embodiments, the one battery cell can be from the same system. In other embodiments, the one battery cell can be from another, but similar, system. In some embodiments the improvement system can take inputs from other sources.

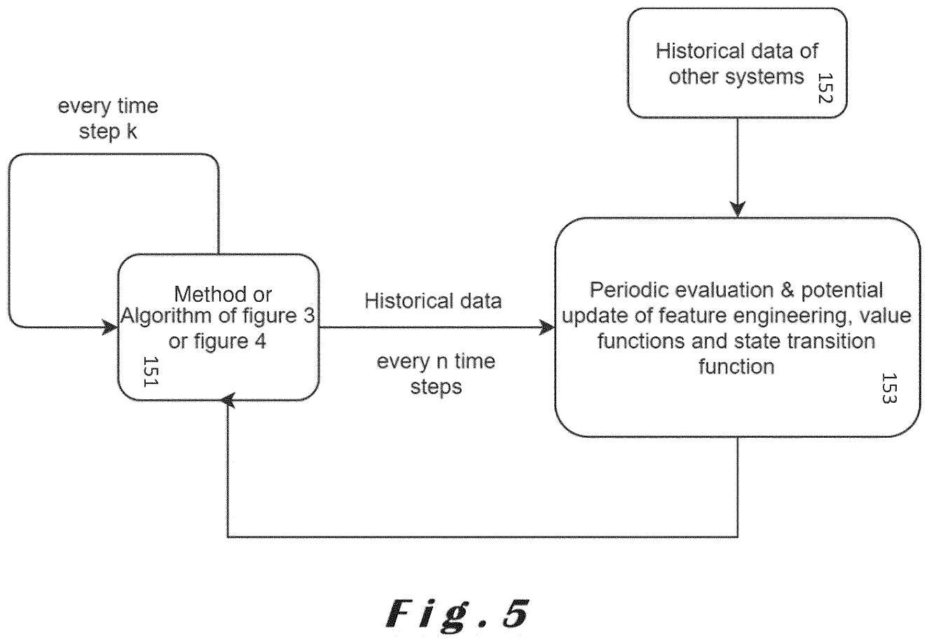

A diagram of an iteration loop according to an embodiment of the invention is illustrated in FIG. 5.

At every time step k, a method or algorithm as described in FIG. 3 or FIG. 4 is run as illustrated by reference number 151 on FIG. 5. Historical data of each iteration in the methods of FIG. 3 and FIG. 4 is each time stored. Further, historical data of other systems is also stored and made available as illustrated by reference number 152 on FIG. 5. Every n time steps, an evaluation is made using the historical data of the system combined optionally with historical data of other systems. The periodic evaluation 153 comprises a potential update of feature engineering and the features used in the state x, a potential update of the value function, a potential update of the state transition function and/or a potential update of the Q-function. By doing this, the system is continuously improved by historical data. In other words, the system is learning continuously. If the evaluation is resulting in an update, the update is used in steps 142 or 122 at a next time step in the method of FIG. 3 or FIG. 4, respectively.

In an embodiment of the invention the application of the BESS is focused to increase the stability of the electrical grid. Electrical grids are not designed to inject large amounts of power causing congestion on the electrical grid or voltages to the grid which are beyond allowed operating conditions. Therefore, by controlling the power setpoint according to a method as described in the current description, this problem can be solved. One of the measurements used in this embodiment are the power measurements of the connection point of the BESS with the electrical grid. Other measurements such as PV power measurements and weather forecasts may further be used. Limits of import or export of the electrical grid as well as forecasts of power needs are further data which may be used in this embodiment to optimize the power setpoints according to a method as earlier described.

In a further embodiment of the invention, the application of the BESS is peak shaving. In this embodiment, the battery storage system is used to reduce the consumption peak of the energy consumer. This is useful for instance, in case the energy consumer has a limited electrical grid connection capacity but needs to have a larger power peak consumption than allowed by its grid connection capacity. By having a BESS installed at the consumer's site or building, the consumer can draw the additional required power from the battery pack in the BESS, while the power at the grid connection will remain below the capacity limit.

After the power peak has occurred, the battery pack needs to be recharged to be ready for the next power peak. The power setpoint to recharge the battery pack can be optimised using a method according to one of the embodiments of the invention described earlier in the current description. The power setpoint optimisation needs to ensure that the battery pack is charged sufficiently for the next power peak. Therefore, it is preferred the battery charges rapidly, at high power. However, charging the battery rapidly at high power will degrade the battery cells quicker, resulting in less capacity. In addition, charging at high power increases efficiency losses due to increased resistive losses. As a result, the optimisation method needs to determine the optimal power setpoint, which is high enough for the battery pack to be charged sufficiently for the next power consumption peak, but also not too high to reduce battery cell degradation and efficiency losses. Applying a method according to an embodiment of the invention as described in the current description, the method uses raw measurements of the battery cells as input to know the temperatures and voltages of the cells because the temperatures and voltages of the battery cells have an impact on the efficiency of the battery pack and are an indication of the degradation of the battery cells. The method will also use power, voltage and current measurements of the power conversion module (PCM), both at the DC side (i.e. the battery side), and at the AC side (the grid connection side), to know the efficiency losses of the PCM. Lastly, the method may use the power, voltage and current measurements from the site or building where the battery is installed, as well as a forecast of power consumption profile and the grid connection capacity limit.

In an embodiment of the invention, the grid connection capacity limit can vary over time. This can happen for instance in a microgrid, a local energy community, or a regular distribution grid with other users and a congestion point. The total grid capacity of the microgrid, the local energy community, or the local distribution grid is limited. At the same time, other energy consumers are also using this grid. Therefore, when one energy consumer utilises a high amount of the available grid capacity, less grid capacity is left for the other grid user. A BESS according to an embodiment of the invention solves this problem. The grid user having less grid capacity can still consume a high-power peak from the battery pack in the BESS. Once the other grid user is using less of the total grid capacity again, the peak shaving limit of the battery pack can be increased.

In this case, the optimisation method according to an embodiment of the invention as described earlier in the application also takes into account future grid connection capacity limits and consumption of other users on the grid. Additionally, to the data points mentioned above, the optimisation method will need real-time data and forecasts of the grid connection capacity limits, the power flows on the grid, and the consumption of other users.

1. A computer-implemented method (100, 120) for determining a power setpoint in a battery energy storage system, BESS, used for an application or service, wherein the BESS comprises a battery pack and a power conversion module, wherein the battery pack comprises battery cells and wherein the BESS further comprises means for capturing measurements of the battery cells, the battery pack and the power conversion module, the method comprising
(a) obtaining raw measurements of the battery cells (101);
(b) obtaining raw measurements of the battery pack (102);
(c) obtaining raw measurements of the power conversion module, PCM (103);
(d) receiving external data relevant for the application or service (104);
(e) applying feature engineering (110) on the group of the raw measurements of the battery cells combined with the raw measurements of the battery pack combined with the raw measurements of the PCM combined with the external data relevant for the application or service to create a state x;
(f) preparing at least one optimization function (112) configured to use state x to optimize an action u;
(g) optimizing (114) the action u with the at least one optimization function wherein the action u comprises the power setpoint;
(h) sending (115) the power setpoint to the PCM; and
(i) setting (116) the power setpoint at the PCM.

2. The computer-implemented method of claim 1, wherein the raw measurements of the battery cells comprise the voltages of the battery cells and the temperatures of at least a subset of the battery cells.

3. The computer-implemented method according to claim 2, wherein the feature engineering comprises selecting the minimum, maximum and average voltages of the battery cells, and selecting the minimum, maximum and average temperatures of the battery cells.

4. The computer-implemented method according to any one of the preceding claims, wherein the raw measurements of the battery pack comprise a current going through the battery pack.

5. The computer-implemented method according to claim 4, wherein the feature engineering comprises selecting the minimum, maximum and average voltages of the battery cells, and selecting the minimum, maximum and average temperatures and selecting the minimum and maximum currents going through the battery pack.

6. The computer-implemented method according to any one of the preceding claims, wherein the raw measurements of the PCM comprise AC and/or DC currents, AC and/or DC voltages, grid frequency or powers.

7. The computer-implemented method according to claim 6, wherein the feature engineering comprises selecting the aggregated AC or DC power of the PCM over time.

8. The computer-implemented method according to any one of the preceding claims, wherein applying feature engineering comprises creating a feature that corresponds to the remaining energy capacity of the battery cells.

9. The computer-implemented method according to any one of the preceding claims, wherein the method further comprises storing the raw measurements and data from steps (a) to (d) to create historical measurements and data, and wherein the feature engineering of step (e) is applied on the group of the raw measurements of the battery cells combined with the raw measurements of the battery pack combined with the raw measurements of the PCM combined with the external data relevant for the application or service combined with the historical measurements and data.

10. The computer-implemented method according to any one of the preceding claims, wherein the at least one optimization function comprises a cost function and a value function, wherein the cost function provides an indication of the current cost and wherein the value function takes into account an estimated future cost and provides an indication of the future cost.

11. The computer-implemented method according to any one of the preceding claims, wherein the at least one optimisation function is
$${min}_{u ∈ U ( x )} E [ g ( x , {u}_{} , w ) + α J ( f ( x , u , w ) ) ]$$
wherein
g(x, u, w) is a cost function, a function dependent on the state x, the action u and a stochastic variable w,
and J(x′) is the value function of the next state x′, wherein the next state x′ is determined by a state transition function ƒ(x, u, w): x′=ƒ(x, u, w), and
α is a parameter having a value between 0.1 and 1, preferably between 0.5 and 1, and more preferably between 0.9 and 0.999.

12. The computer-implemented method according to any one of claims 1 to 9, wherein the at least one optimisation function is
$${min}_{u ⊂ U ( x )} Q ( x , u )$$
wherein
Q(x, u) is a function dependent on the state x and the action u, which is recursively defined as:
$$Q ( x , u ) = E ⌈ g ( x , u , w ) + α {min}_{u ∈ U ( x ′ )} Q ( {x}^{′} , u ) ⌉$$
wherein
g(x, u, w) is a cost function, a function dependent on the state x, the action u and a stochastic variable w,
and the next state x′ is determined by a state transition function ƒ(x, u, w): x′=ƒ(x, u, w), and
α is a parameter having a value between 0.1 and 1, preferably between 0.5 and 1, and more preferably between 0.9 and 0.999.

13. The computer-implemented method according to any one of the preceding claims, wherein the raw measurements of the battery cells comprise the internal resistance of the battery cells.

14. The computer-implemented method according to any one of the preceding claims, wherein steps (a) to (e) are repeated to create new states x′ and wherein the at least one optimisation function is updated over time based on the state x, the new state x′, the action u and the previously used optimisation function at step (g).

15. The computer-implemented method according to any one of the preceding claims, wherein all information of each step in the method is stored to create first historical data and wherein the at least one optimisation function is updated over time based on the first historical data.

16. The computer-implemented method according to any one of the preceding claims, further comprising retrieving historical data from other, similar systems to create second historical data and wherein the at least one optimisation function is updated over time based on the second historical data.

17. The computer-implemented method according to claim 11, wherein steps (a) to (e) are repeated to create new states x′ and to observe a realization of the stochastic variables ŵ and a corresponding observed cost function ĝ from repeated steps (a) to (d), and wherein the at least one value function J(x) is updated over time based on the state x, the new state x′, the action u and the observed cost function ĝ.

18. The computer-implemented method according to claim 12, wherein steps (a) to (e) are repeated to create new states x′ and to observe a realization of the stochastic variables ŵ and a corresponding observed cost function ĝ from repeated steps (a) to (d), and wherein the at least one value function Q(x, u) is updated over time based on the state x, the new state x′, the action u and the observed cost function ĝ.

19. A battery energy storage system (10) configured to store and release electrical energy and used for an application or service, the battery energy storage system, BESS, comprising,
a set of rechargeable battery cells (14) electrically connected to form a battery pack (12);
a power conversion module (16), PCM, in communication with the battery pack and configured to transfer and modulate electrical energy being transferred between the battery pack and an electrical grid according to a power setpoint;
means for obtaining raw measurements from the set of rechargeable battery cells, the battery pack and the PCM;
means for receiving external data relevant for the application or service; and
a controller in communication with the means for obtaining raw measurements from the set of rechargeable battery cells, the battery pack and the PCM, with the PCM and with the means for receiving external data and configured to (a) obtain raw measurements from the set of rechargeable battery cells, the battery pack and the PCM and to (b) obtain external data;
wherein the controller is further configured to (c) apply feature engineering on the obtained raw measurements and external data to create a state x, to (d) prepare at least one optimization function (112) configured to use state x to optimize an action u, to (e) optimize (114) the action u with the at least one optimization function wherein the action u comprises the power setpoint, and to (f) send the power setpoint to the PCM, and wherein the PCM is configured to (g) set the received setpoint.

20. The battery energy storage system according to claim 19, wherein the raw measurements of the battery cells comprise the voltages of the battery cells and the temperatures of the battery cells.

21. The battery energy storage system according to claim 20, wherein the feature engineering comprises selecting the minimum, maximum and average voltages of the battery cells, and selecting the minimum, maximum and average temperatures of the battery cells.

22. The battery energy storage system according to any one of claims 19 to 21, wherein raw measurements of the battery cells further comprise a current going through the battery cells.

23. The battery energy storage system according to claim 22, wherein the feature engineering comprises selecting the minimum, maximum and average voltages of the battery cells, and selecting the minimum, maximum and average temperatures and selecting the minimum and maximum currents going through the battery cells.

24. The battery energy storage system according to any one of claims 19 to 23, wherein the raw measurements of the PCM comprise AC and/or DC currents, AC and/or DC voltages, grid frequency or powers.

25. The battery energy storage system according to claim 24, wherein the feature engineering comprises selecting the aggregated AC or DC power of the PCM over time.

26. The battery energy storage system according to any one of claims 19 to 25, wherein applying feature engineering comprises creating a feature that corresponds to the remaining energy capacity of the battery cells.

27. The battery energy storage system according to any one of claims 19 to 26, wherein the controller is further configured to store the raw measurements and data from controlling steps (a) to (b) to create historical measurements and data, and wherein the controller is further configured to apply feature engineering on the group of the raw measurements of the battery cells combined with the raw measurements of the battery pack combined with the raw measurements of the PCM combined with the external data relevant for the application or service combined with the historical measurements and data.

28. The battery energy storage system according to any one of claims 19 to 27, wherein the at least one optimization function comprises a cost function and a value function, wherein the cost function provides an indication of the current cost and wherein the value function takes into account an estimated future cost and provides an indication of the future cost.

29. The battery energy storage system according to any one of claims 19 to 28, wherein the at least one optimisation function is
$${min}_{u ∈ U ( x )} E [ g ( x , {u}_{} , w ) + α J ( f ( x , u , w ) ) ]$$
wherein
g(x, u, w) is a cost function, a function dependent on the state x, the action u and a stochastic variable w,
and J(x′) is the value function of the next state x′, wherein the next state x′ is determined by a state transition function ƒ(x, u, w): x′=ƒ(x, u, w), and
α is a parameter having a value between 0.1 and 1, preferably between 0.5 and 1, and more preferably between 0.9 and 0.999.

30. The battery energy storage system according to any one of claims 19 to 28, wherein the at least one optimisation function is
$${min}_{u ∈ U ( x )} Q ( x , u )$$
wherein
Q(x, u) is a function dependent on the state x and the action u, which is recursively defined as:
$$Q ( x , u ) = E [ g ( x , u , w ) + α {min}_{u ⊂ U ( x ′ )} Q ( {x}^{′} , u ) ]$$
wherein
g(x, u, w) is a cost function, a function dependent on the state x, the action u and a stochastic variable w,
and the next state x′ is determined by a state transition function ƒ(x, u, w): x′=ƒ(x, u, w), and
α is a parameter having a value between 0.1 and 1, preferably between 0.5 and 1, and more preferably between 0.9 and 0.999.

31. The battery energy storage system according to any one of claims 19 to 30, wherein the raw measurements of the battery cells comprise the internal resistance of the battery cells.

32. The battery energy storage system according to any one of the claims 19 to 31, wherein the controller is configured to repeat (a) to (c) to create new states x′ and wherein the controller is further configured to update the at least one optimisation function over time based on the state x, the new state x′, the action u and the previously used optimisation function of controlling step (e).

33. The battery energy storage system according to any one of the claims 19 to 32, wherein the controller is configured to store all information of each controlling step (a) to (f) to create first historical data and wherein the controller is further configured to update the at least one optimisation function over time based on the first historical data.

34. The battery energy storage system according to any one of the claims 19 to 33, wherein the controller is configured to retrieve historical data from other, similar systems to create second historical data and wherein the controller is further configured to update the at least one optimisation function over time based on the second historical data.

35. The battery energy storage system according to claim 29, wherein the controller is configured to repeat controlling steps (a) to (c) to create new states x′ and to observe a realization of the stochastic variables ŵ and corresponding cost function ĝ from the repeated controlling steps (a) to (b), and wherein the at least one value function J(x) is updated over time based on the state x, the new state x′, the action u and the observed cost function ĝ.

36. The battery energy storage system according to claim 30, wherein the controller is configured to repeat controlling steps (a) to (c) to create new states x′ and to observe a realization of the stochastic variables ŵ and corresponding cost function ĝ from the repeated controlling steps (a) to (b), and wherein the at least one value function Q(x, u) is updated over time based on the state x, the new state x′, the action u and the observed cost function ĝ.
